(19) United States
(12) Patent Application Publication
(10) Pub. No.: US 2002/0125986 A1
(43) Pub. Date: Sep. 12, 2002

(54) Method for fabricating ultra high-resistive conductors in semiconductor devices and devices fabricated

(75) Inventors: Cyril Cabral JR., Ossining, NY (US); Lawrence Clevenger, LaGrangeville, NY (US); Louis Lu-Chen Hsu, Fishkill, NY (US); Keith Kwong Hon Wong, Wappingers Falls, NY (US)

Correspondence Address: RANDY W. TUNG, TUNG & ASSOCIATES, Suite 120, 838 W. Long Lake Road, Bloomfield Hills, MI, 48302, US

(73) Assignee: International Business Machines Corporation, Armonk, NY (US)

(21) Appl. No.: 09/760,240

(22) Filed: Jan. 12, 2001

(51) Int. Cl. H01C 1/012

(52) U.S. Cl. 338/308; 338/307; 338/309

(57) ABSTRACT

A high density resistor structure and a method for forming the structure are disclosed. The high density resistor structure can be constructed by an electrically insulative substrate; a refractory metal-silicon-nitrogen layer deposited on the top surface; and at least one resistor element patterned in the refractory metal-silicon-nitrogen layer in a plane parallel to the top surface. The method can be carried out by first providing the electrically insulative semiconductor substrate or a glass substrate, then sputter-depositing a TaSiN layer having a thickness between 200 Å and 2000 Å on top of the substrate; and then forming by a reactive ion etching technique at least one resistor element in the TaSiN film in a plane that is parallel to the top surface of the substrate.

### FIELD OF THE INVENTION

The present invention generally relates to a method for fabricating high-resistive conductors in semiconductor devices and devices formed and more particularly, relates to a method for fabricating ultra high-resistive conductors that are formed of refractory metal-silicon-nitrogen for use in semiconductor devices and devices formed.

### BACKGROUND OF THE INVENTION

In the fabrication of electronic devices, resistors are connected to a circuit board for providing specific electrical resistances to an electronic circuit. When semiconductor devices are fabricated, it is difficult to provide resistors in-situ in the semiconductor structure. Particularly, it has not been possible to form resistors in-situ in the structure that provide high resistance in the range of more than several thousand Ω/sq. The only in-situ formed resistor designed for use in a semiconductor device has been a diffusion resistor that is normally formed on the surface of a substrate. The diffusion type resistors are utilized since their resistivity can be accurately controlled. Doped polysilicon resistors are known to have unstable material characteristics, due to a grain boundary effect, i.e. the resistivity will decrease when annealed due to grain growth. One reason for such difficulty is the unavailability of a material that can be used in a semiconductor fabrication process which has sufficiently high electrical resistivity. Any material that is capable of forming a high value, i.e. in the range of 100 K-Ω to ten or higher M-Ω, resistor and is thermally stable is extremely desireable in semiconductor circuit design.

As an example, a voltage divider 12 often used in a charge pump circuit is used to set the voltage level as shown in FIG. 1. For a stand-by pump especially, it is desirable to have high-ohm resistors to form the voltage divider so that a DC current that flows can be reduced. By using the conventional diffusion resistors, the sheet resistance is in the range between 300 Ω/sq to 3000 Ω/sq which results in a requirement for a large circuit layout area. Circuits such as band-gap reference, power-on sequencer, voltage generator that are commonly needed in analog and digital designs all require high-ohm resistors.

FIG. 2 illustrates another application for high-ohm resistors for tieing an intermediate node 14 so that voltage at the node is set at certain DC level. It is useful especially to set the initial conditions of the node, or to prevent dielectric breakdown caused by a high voltage applied across a capacitor, or diffusion junctions.

It is therefore an object of the present invention to provide a high density resistor structure or a small sized high-ohm resistor that does not have the drawbacks or shortcomings of the conventional low-density diffusion resistors.

It is another object of the present invention to provide a high density resistor structure that can be in-situ formed in a semiconductor structure.

It is a further object of the present invention to provide a high density resistor structure that can be in-situ formed of a refractory metal-silicon-nitrogen alloy.

It is another further object of the present invention to provide a high density resistor structure that can be formed in-situ in a semiconductor structure by sputter-depositing a refractory metal-silicon-nitrogen layer onto the semiconductor structure.

It is still another object of the present invention to provide a high density resistor structure in a semiconductor device by first sputter-depositing a refractory metal-silicon-nitrogen and then forming the resistor by a photo-masking and etching process.

It is yet another object of the present invention to provide a high density resistor structure in a semiconductor device by an in-situ method wherein a refractory metal-silicon-nitrogen layer is deposited to a thickness between about 300 Å and about 700 Å.

It is still another further object of the present invention to provide a method for forming a high density resistor by first depositing a layer of a refractory metal-silicon-nitrogen and then patterning the layer into at least one resistor element.

It is yet another further object of the present invention to provide a method for forming a high density resistor in a semiconductor structure by first sputter-depositing a layer of tantalum-silicon-nitrogen and then patterning the layer by a photo-mask and etch to form at least one resistor element.

### SUMMARY OF THE INVENTION

In accordance with the present invention, a high density resistor structure and a method for forming the high density resistor structure are disclosed.

In a preferred embodiment, a high density resistor structure is provided which includes an electrically insulated substrate that has a top surface; a refractory metal-silicon-nitrogen layer deposited on the top surface; and at least one resistor element patterned in the refractory metal-silicon-nitrogen layer in a plane parallel to the top surface.

In the high density resistor structure, the at least two resistor elements are electrically connected in series or in parallel. The electrically insulated substrate may be a semiconductor substrate, or a glass substrate. The refractory metal-silicon-nitrogen may be a member selected from the group consisting of TaSiN, NbSiN, VSiN and WSiN. The refractory metal-silicon-nitrogen layer may be deposited to a thickness between about 200 Å and about 2000 Å, or preferably, to a thickness between about 300 Å and about 700 Å. The refractory metal-silicon-nitrogen layer may be TaSiN deposited to a thickness of about 500 Å.

In the high density resistor structure, the refractory metal-silicon-nitrogen layer may be TaSiN containing between about 10 at % and about 55 at % Ta, between about 10 at % and about 45 at % Si, and between about 30 at % and about 80 at % N. The refractory metal-silicon-nitrogen layer may be TaSiN containing preferably between about 45 at % and about 80 at % N. The refractory metal-silicon-nitrogen layer may be TaSiN that has a sheet resistance between about 1 K-Ω/sq and about 1 M-Ω/sq.

The present invention is further directed to a method for forming a high density resistor which can be carried out by the operating steps of first providing an electrically insulating substrate that has a top surface thereon; depositing a layer of a refractory metal-silicon-nitrogen; and patterning the layer of refractory metal-silicon-nitrogen into at least one resistor element.

The method for forming a high density resistor may further include the step of depositing the layer of refractory metal-silicon-nitrogen as a TaSiN material. This may be done by sputtering from a Ta—Si alloy target in the presence of N₂ gas, or co-sputtering from a Ta target and a Si target in the presence of N₂ gas. Other techniques are co-evaporation in the presence of N₂ or CVD (chemical vapor deposition). The method may further include the step of co-sputtering from a Ta target at between about 80 W DC and about 120 W DC and a Si target at between about 500 W RF and about 700 W RF. The method may further include the step of co-sputtering from a Ta target and a Si target at a deposition pressure between about 2 mTorr and about 10 mTorr in an Ar sputtering plasma that contains from about 2% to about 30% N₂. The method may further include the step of patterning the layer of refractory metal-silicon-nitrogen by a reactive ion etching technique utilizing a photo-resist mask, or the step of patterning the layer of refractory metal-silicon-nitrogen in a Cl₂/O₂ gas mixture, or in a Cl₂ gas.

### BRIEF DESCRIPTION OF THE DRAWINGS

These and other objects, features and advantages of the present invention will become-apparent from the following detailed description and the appended drawings in which:

FIG. 1 illustrates a voltage divider used in a charge pump circuit.

FIG. 2 illustrates the use of a high-ohm resistor to tie an intermediate node at a pre-determined DC voltage level.

FIG. 3 illustrates a data table containing various TaSiN compositions and their respective resistivity values.

FIG. 4 is an enlarged, top view of a physical layout for a conventional diffusion type resistor contained within a charge-pump control circuit.

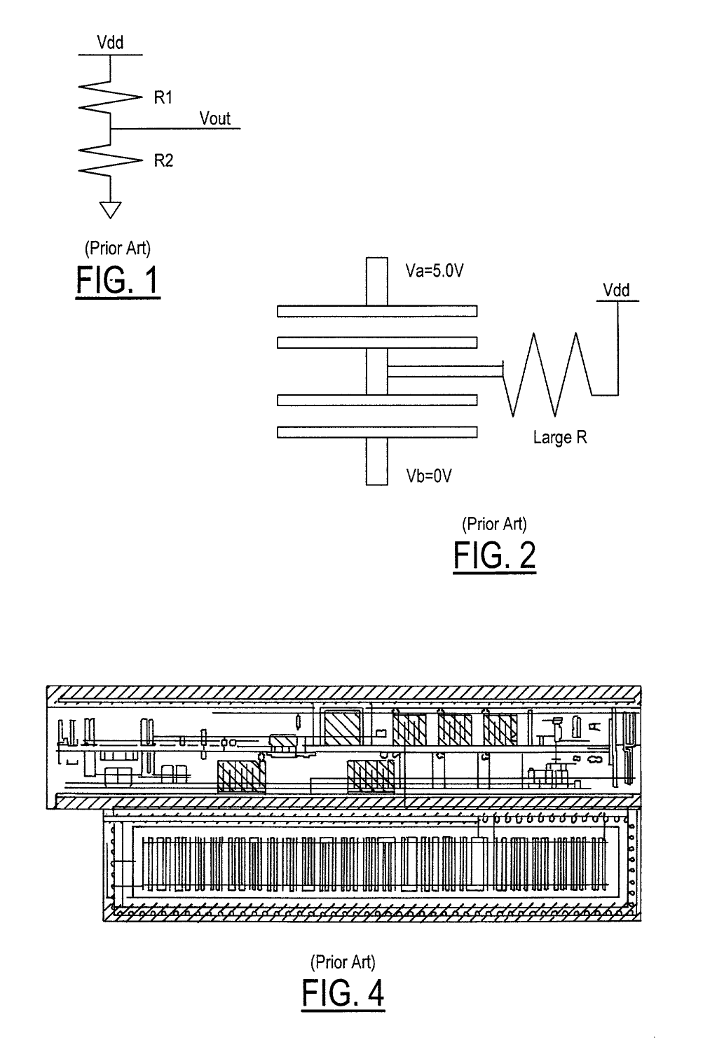

### DETAILED DESCRIPTION OF THE PREFERRED EMBODIMENT

The present invention discloses a high density resistor structure that includes an electrically insulative substrate, either an insulated semiconductor substrate or a glass substrate which has a top surface; a refractory metal-silicon-nitrogen layer deposited on the top surface; and at least one resistor element patterned in the refractory metal-silicon-nitrogen layer in a plane parallel to the top surface.

As shown in a preferred embodiment, TaSiN is used as the refractory metal-silicon-nitrogen deposited to a thickness between about 200 Å and about 2000 Å, and preferably between about 300 Å and about 700 Å. In a typical application, the TaSiN composition may be formed of between about 10 at % and about 55 at % Ta, between about 10 at % and about 45 at % Si, and between about 30 at % and about 80 at % N; and preferably between about 45 at % and about 80 at % N. The refractory metal-silicon-nitrogen layer may be suitably deposited and then patterned into a thin-wire configuration. The refractory metal-silicon-nitrogen layer, i.e. a TaSiN layer, should have a sheet resistance between about 1 K-Ω/sq and about 1 M-Ω/sq.

The present invention further discloses a method for forming a high density resistor that can be carried out by the operating steps of first providing an electrically insulating substrate, such as an oxidized or nitrided semiconductor substrate or a glass substrate that has a top surface thereon; then depositing a layer of a refractory metal-silicon-nitrogen and patterning the layer of refractory metal-silicon-nitrogen into at least one resistor element. The deposition process for the refractory metal-silicon-nitrogen can be advantageously carried out by a sputtering technique. For instance, when a TaSiN layer is to be deposited, the sputtering can be carried out from either a Ta—Si alloy target in the presence of N₂ gas (preferred embodiment), or from co-sputtering a Ta target and a Si target in the presence of N₂ gas. In the co-sputtering process, the sputtering of TaSiN is carried out by sputtering from a Ta target at between about 80 W DC and about 120 W DC, and a Si target at between about 500 W RF and about 700 W RF. The co-sputtering process from a Ta target and a Si target may further be carried out at a chamber pressure between about 2 mTorr and about 10 mTorr sputtering plasma that contains between 2% and about 30% N₂. The method further includes the patterning step which can be advantageously carried out by a reactive ion etching technique using a photo-resist mask. The reactive ion etching process can be carried out in a Cl₂ gas, or in a Cl₂/O₂ gas mixture.

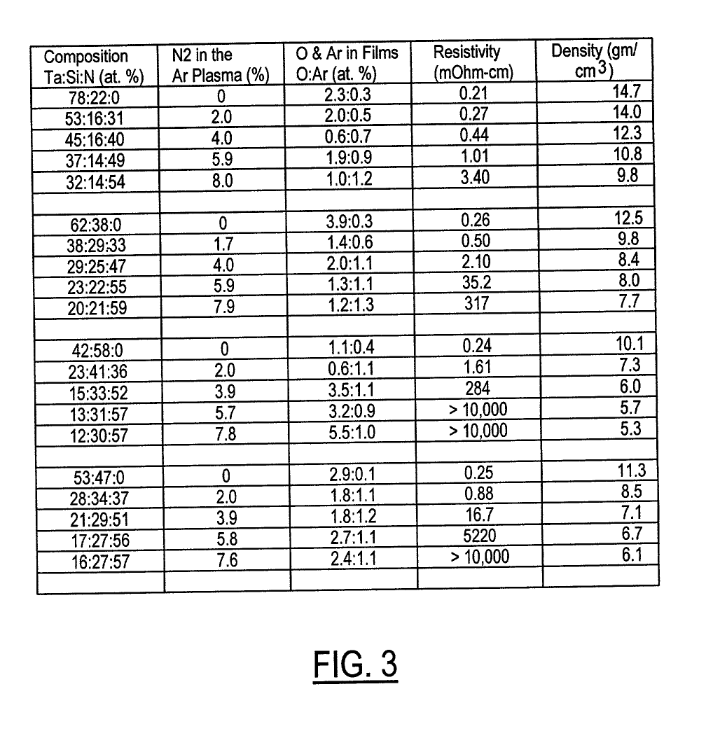

In the present invention novel structure of a high density resistor, a refractory metal-silicon-nitrogen film such as TaₓSi_{y}N_{z} is patterned to form resistors for a semiconductor device. In these applications, the ratio of X:Y:Z, i.e. the ratio of Ta:Si:N is set during the sputtering deposition of the films in order to produce a resistor with the desired sheet resistance, according to the data shown in FIG. 3. For instance, the Ta:Si:N material may be suitably selected to have desirable properties such that its resistivity varies between about 210 μΩ-cm and about 1E7 μΩ cm depending on the ratio of Ta:Si:N in the deposited film. A full range of experimentally measured compositions and resistivities are shown in the table of FIG. 3.

Another benefit made possible by the present invention novel refractory metal-silicon-nitrogen materials is that the material remains thermally stable up to annealing temperatures from 800° C. to 1100° C., depending on the composition of the films. The films in the as-deposited state are amorphous, i.e. with no grain boundaries, in the microstructure. Upon annealing, the amorphous structure becomes a crystalline structure, depending on the nitrogen content of the films. For instance, films that have greater than 40 at. % nitrogen remain stable up to temperatures approaching 1100°C.

In the preferred embodiment of the invention, TaₓSi_{y}N_{z} can be used to replace implanted resistors in the circuitry of the semiconductor devices. For instance, from an observation of data in FIG. 3, a Ta:Si:N ratio of 20:21:59 or 17:27:56 produces a ohm/sq sheet resistance of 0.06 and 1.0 MΩ/sq respectively for a 500 Å thick film.

As shown in FIG. 4, a suitable application of the present invention novel high density resistor structure is illustrated. An example of an implanted polysilicon resistor of 6956 μm in length and designing sheet resistance of 600 Ω/sq is illustrated. The actual space taken up by the resistor is much smaller when the implanted polysilicon resistor is replaced by a TaₓSi_{y}N_{z} resistor, i.e., the equivalent TaSiN resistor is only 4.0 μm long. The calculation is illustrated below.

The comparison of chip area benefit by replacing an implanted poly-Si resistor with the present invention high density resistor is illustrated. FIG. 4 shows a typical serpentine layout for a standard implanted or diffusion resistor. The approximate size of the resistor block is about 132 μm×26 μm. Assuming a 0.5 μm pitch, a 0.25 μm line width, and using a design specified sheet resistance value of 600 Ω/sq, a calculated value for the resistance of the entire implanted resistor is:

$$\begin{matrix}Number of squares \times Ω / sq = [ ( ( \frac{132}{0.5} + 1 ) 26 \times \frac{1}{0.25} ) + \\ ( \frac{132}{0.5} ) ] 600 Ω / sq = 16.7 M Ω\end{matrix}$$

By utilizing the present invention novel structure to replace the implanted resistor, the number of required squares can be greatly reduced to achieve the same resistance value. Assuming a 500 Å thickness film, the following number of squares would be required:

Number of squares needed=16.7 MΩ/(p/t)

where ρ is the material resistivity and is the material deposited thickness.

From the data in FIG. 3, using Ta:Si:N of a ratio of 17:27:56, ρ=5220×10⁻³ Ω-cm, while t=500×10⁻⁸ cm (at 500 Å thickness).

Number of squares needed=16.7×10⁶Ω/(5220×10⁻³ Ω-cm/500×10⁻⁸ cm)=16 squares

Assuming a 0.25 μm linewidth, the total length of the Ta₁₇Si₂₇N₅₆ line needed=4 μm.

In conclusion, the length of an implanted polysilicon resistor needed for 16.7 MΩ is about 6956 μm, while the length required by using Ta₁₇Si₂₇N₅₆ for 16.7 MΩ is 4 μm. A 99.9% area saving is achieved by using the present invention novel method and material.

The present invention novel high density resistor material utilizes, in a preferred embodiment, a Ta:Si:N layer that consists of between about 10 at % and about 55 at % Ta, between about 10 at % and about 45 at % Si, and between about 30 at % and about 80 at % N. The preferred range for N is from 45 at % to 80 at % which is estimated from a serpentine structure having an area of 26 μm by 132 μm, with a linewidth of 0.25 μm and a pitch of 0.50 μm which produces 27.8×10³ squares. Assuming the need of resistors larger than 100 KΩ, the sheet resistance values needed will be greater than 3.6 Ω/sq. Assuming a thin film thickness of 100 nm to 1 μm, this would require a material with a resistivity greater than 36 μΩ-cm for the 100 nm thickness, and greater than 0.36 mΩ-cm for the 1 μm thickness film. This would cover the full nitrogen range described previously, i.e. 30 at % to 80 at %. If assuming a 100× decrease in area, or 278 sq, a material that has a resistivity of 3.6 mΩ-cm or greater is then required. This is covered by the preferred nitrogen range of 45-80 at %.

The present invention novel high density resistor structure may further be utilized in other possible applications. For instance, when a RC delay is required, i.e. to build a DRAM refresh base clock, if a small-sized high-ohm resistor is used, then a large-sized capacitor can be avoided.

The present invention novel high density resistor structure and a method for fabricating the structure have therefore been amply described in the above description and in the appended drawing of FIG. 3.

While the present invention has been described in an illustrative manner, it should be understood that the terminology used is intended to be in a nature of words of description rather than of limitation.

Furthermore, while the present invention has been described in terms of a preferred embodiment, it is to be appreciated that those skilled in the art will readily apply these teachings to other possible variations of the inventions.

The embodiment of the invention in which an exclusive property or privilege is claimed are defined as follows.

1. A high density resistor structure comprising:
a substrate having a top insulating surface;
a refractory metal-silicon-nitrogen layer deposited on said top surface; and
at least one resistor element formed of said refractory metal-silicon-nitrogen layer in a plane parallel to said top surface.

2. A high density resistor structure according to claim 1, wherein said at least one resistor element being at least two resistor elements electrically connected in series or in parallel.

3. A high density resistor structure according to claim 1, wherein said electrically insulative substrate is a semiconductor substrate.

4. A high density resistor structure according to claim 1, wherein said electrically insulative substrate is a glass substrate.

5. A high density resistor structure according to claim 1, wherein said refractory metal-silicon-nitrogen is a member elected from the group consisting of TaSiN, NbSiN, VSiN and WSiN.

6. A high density resistor structure according to claim 1, wherein said refractory metal-silicon-nitrogen layer is deposited to a thickness between about 200 Å and about 2000 Å.

7. A high density resistor structure according to claim 1, wherein said refractory metal-silicon-nitrogen layer is deposited preferably to a thickness between about 300 Å and 700 Å.

8. A high density resistor structure according to claim 1, wherein said refractory metal-silicon-nitrogen layer is deposited to a thickness of about 500 Å.

9. A high density resistor structure according to claim 1, wherein said refractory metal-silicon-nitrogen layer is TaSiN containing between about 10 at % and about 55 at % Ta, between about 10 at % and about 45 at % Si, and between about 30 at % and about 80 at % N.

10. A high density resistor structure according to claim 1, wherein said refractory metal-silicon-nitrogen layer is TaSiN containing preferably between about 45 at % and about 80 at % N.

11. A high density resistor structure according to claim 1, wherein said refractory metal-silicon-nitrogen layer is TaSiN patterned into a wiring configuration.

12. A high density resistor structure according to claim 1, wherein said refractory metal-silicon-nitrogen layer is TaSiN having a sheet resistance between about 1 K-Ω/sq and about 1 M-Ω/sq.

13. A high density resistor structure according to claim 1, wherein said refractory metal-silicon-nitrogen layer is TaSiN having preferably a sheet resistance between about 10 K-Ω/sq and about 0.3 M-Ω/sq.

14. A method for forming a high density resistor comprising the steps of:
providing an electrically insulating substrate having a top surface thereon;
depositing a layer of a refractory metal-silicon-nitrogen; and
patterning said layer of refractory metal-silicon-nitrogen into at least one resistor element.

15. A method for forming a high density resistor according to claim 14 further comprising the step of depositing said layer of refractory metal-silicon-nitrogen in a TaSiN material.

16. A method for forming a high density resistor according to claim 15 further comprising the step of sputtering from a Ta—Si alloy target in the presence of N₂ gas.

17. A method for forming a high density resistor according to claim 15 further comprising the step of co-sputtering from a Ta target and a Si target in the presence of N₂ gas.

18. A method for forming a high density resistor according to claim 15 wherein said step of depositing the layer of refractory metal-silicon-nitrogen being conducted by co-evaporating a Ta source and a Si source in the presence of N₂.

19. A method for forming a high density resistor according to claim 15 wherein said step of depositing the layer of refractory metal-silicon-nitrogen being conducted in a chemical vapor deposition (CVD) chamber.

20. A method for forming a high density resistor according to claim 15 further comprising the step of co-sputtering from a Ta target at between about 80 W DC and about 120 W DC, and a Si target at between about 500 W RF and about 700 W RF.

21. A method for forming a high density resistor according to claim 15 further comprising the step of co-sputtering from a Ta target and a Si target at a depositron pressure between about 2 mTorr and about 10 mTorr in an Ar sputtering plasma that contains between 2% and about 30% N₂.

22. A method for forming a high density resistor according to claim 16 further comprising the step of patterning said layer of refractory metal-silicon-nitrogen by a reactive ion etching technique using a photo-resist mask.

23. A method for forming a high density resistor according to claim 16 further comprising the step of patterning said layer of refractory metal-silicon-nitrogen in a Cl₂/O₂ gas mixture.

24. A method for forming a high density resistor according to claim 16 further comprising the step of patterning said layer of refractory metal-silicon-nitrogen in a Cl₂ gas.

25. A method for forming a high density resistor according to claim 16, wherein an area of said TaSiN is a high density resistor not larger than 100×10⁻⁶ M².
